(19) United States
(12) Patent Application Publication
(10) Pub. No.: US 2007/0229201 A1
(43) Pub. Date: Oct. 4, 2007

(54) FILTER CIRCUIT AND METHOD OF ADJUSTING CHARACTERISTICS THEREOF

(76) Inventors: Fumihiko Aiga, Yokohama-shi (JP); Hiroyuki Kayano, Fujisawa-shi (JP); Noritsugu Shiokawa, Yokohama-shi (JP); Tamio Kawaguchi, Kawasaki-shi (JP); Tatsunori Hashimoto, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/688,525

(22) Filed: Mar. 20, 2007

(30) Foreign Application Priority Data
Apr. 3, 2006 (JP) 2006-102147

(51) Int. Cl. H01P 1/203; H01B 12/02

(52) U.S. Cl. 333/99 S; 333/204; 505/210

(57) ABSTRACT

In a filter circuit, a conductor layer is formed on one side of a dielectric substrate, and a resonator pattern of resonators, input and sections are formed of micro strip lines on the other side of the dielectric substrate. A transmission line coupling the resonators and is also formed of a micro strip line on the other side. An open stub branches off from the transmission line, and the electric length of this open stub is set to an integral multiple of a half-wave length of a resonance wave length corresponding to a resonance frequency of the filter.

### CROSS-REFERENCE TO RELATED APPLICATIONS

This application is based upon and claims the benefit of priority from prior Japanese Patent Application No. 2006-102147, filed Apr. 3, 2006, the entire contents of which are incorporated herein by reference.

### BACKGROUND OF THE INVENTION

1. Field of the Invention

The present invention relates to a filter circuit and a method of adjusting characteristics thereof, and particularly to a bandpass filter used in communication equipment and a method of adjusting characteristics thereof.

2. Description of the Related Art

Communication equipment such as a wireless or wired information communication apparatus comprises various types of high frequency components, such as an amplifier, mixer and filter. Among these high-frequency components, a bandpass filter is provided with an arrangement of resonators which has a function of passing a signal with a particular frequency band.

Generally, when a filter is manufactured but a desired characteristic cannot be obtained, it is necessary to adjust the filter characteristics after manufacture. The filter has a circuit parameter such as a resonance frequency fi, a coupling coefficient between resonators and an external Q. In a conventional method of adjusting the filter characteristics, the resonance frequency fi is adjusted. If an increase of the resonance frequency fi is required, a method of trimming the end of the resonator is applied. If a reduction of the resonance frequency fi is required, a method of arranging a dielectric member in the vicinity of the resonator to increase an apparent dielectric constant is applied. However, in some cases, even if the resonance frequency fi is adjusted, a desired characteristic can not be achieved. In order to enable a more flexible characteristic adjustment, it is required to adjust circuit constants other than the resonance frequency fi.

A method of realizing the coupling between resonators in a filter circuit can be classified roughly into the following two types. Firstly, there is a gap coupling, in which only the positional relation between the resonators is adjusted to realize desired coupling. In such case, no other elements for coupling the resonators are added to the filter circuit. The gap coupling is suitable for a filter circuit such as Chebyshev function type filter, in which the adjacent resonators are coupled each other. Secondly, there is a line coupling, in which a transmission line or lines are provided in the filter circuit to realize a coupling between the resonators. The line coupling is suitable for a filter circuit having a non-adjacent coupling which can achieve an flatness of group of delay times or can provide a sharp skirt characteristic having an attenuation pole.

The adjustment of the gap coupling between the resonators after filter manufacturing requires changes in the relative arrangement between the resonators. Therefore, it is difficult to realize a gap coupling adjustment in reality.

If the adjustment of the line coupling after filter manufacturing is a line coupling via gap as described in “IEEE Microwave Theory and Techniques Symposium Digest (1999), page 1547”, it is possible to adjust the coupling smaller by trimming the transmission line end of the gap section. However, the adjustment to increase coupling is difficult. Moreover, in the line coupling via tap described in JP-A 2004-336605 (KOKAI), the adjustment to neither increase nor reduce coupling is difficult.

Furthermore, there are two ways to realize the external Q in a filter circuit as follows. Firstly, there is a gap excitation, which couples an input line and a resonator via a gap as described in IEEE Transaction on Microwave Theory and Techniques, Vol. 20 (1972), page 719. Secondly, there is a tap excitation, which couples an input line and a resonator via a tap as described in IEEE Transaction on Microwave Theory and Techniques, Vol. 27 (1979), page 44.

As for the gap excitation, the external Q after filter manufacturing can be adjusted in terms of increasing the external Q by trimming the excitation line of the gap section. However, it is difficult to adjust the external Q smaller. As for the tap excitation, it is difficult to adjust the external Q neither larger nor smaller.

Thus, conventionally, it is regarded as difficult to adjust the coupling between resonators and the external Q after filter manufacturing.

### BRIEF SUMMARY OF THE INVENTION

According to an aspect of the present invention, there is provided a filter circuit having a resonance frequency, comprising:

a dielectric substrate having a first surface and a second surface opposed to the first surface;

a conductor layer formed on the first surface;

input and output sections formed of micro strip lines on the second surface;

resonant conductors arranged between the input and output sections and formed of micro strip lines on the second surface;

a transmission line formed of a micro strip line on the second surface and coupled between the resonant conductors; and

an open stub formed of a micro strip line on the second surface and branching off from the transmission line, the electric length of the open stub being an integral multiple of a half-wave length of a resonance wave length corresponding to the resonance frequency.

Also, according to another aspect of the present invention, there is provided a filter circuit having a resonance frequency, comprising:

a dielectric substrate having a first surface and a second surface opposed to the first surface;

a conductor layer formed on the first surface;

input and output sections formed of micro strip lines on the second surface;

a resonant conductor arranged between the input and output sections and formed of a micro strip line on the second surface; and

an open stub formed of a micro strip line on the second surface and branching off from one of the input and the output sections, the electric length of the open stub being an integral multiple of a half-wave length of a resonance wave length corresponding to the resonance frequency.

### BRIEF DESCRIPTION OF THE SEVERAL VIEWS OF THE DRAWING

FIG. 1 is a cross sectional view schematically showing a basic construction of a superconductor filter according to an embodiment.

FIG. 2 is a plain view showing a pattern of a filter circuit for explaining the basic structure of a superconductor filter according to an embodiment.

FIG. 3 is a graph showing a bandpass amplitude characteristic of the filter circuit shown in FIG. 2.

FIG. 4 is a graph showing a change of a filter characteristic when a sapphire rod is arranged above the meander section of an open stub and the end of the rod is drawn close to the meander section in the filter circuit shown in FIG. 3.

FIG. 5 is a graph showing a change of a filter characteristic when the end of the open stub is trimmed in the filter circuit shown in FIG. 3.

FIG. 6 is a plain view showing another pattern of a filter circuit for explaining the basic structure of a superconductor filter according to an embodiment.

FIG. 7 is a graph showing bandpass amplitude characteristic for the filter circuit shown in FIG. 6.

FIG. 8 is a graph showing changes in external Q when a sapphire rod is arranged on the meander section of the open stub and the end of the rod is drawn close to the meander section in the filter circuit shown in FIG. 3.

FIG. 9 is a graph showing changes in the external Q of the coupling when the end of the open stub is trimmed in the filter circuit shown in FIG. 3.

FIG. 10 is a plain view showing a filter pattern of a filter circuit according to yet another embodiment.

FIG. 11 is a perspective view schematically showing a filter provided with the filter circuit shown in FIG. 10.

FIG. 12 is a graph showing a desired characteristic realized in the filter shown in FIG. 11.

FIG. 13 is a plain view showing a modified pattern of the filter circuit shown in FIG. 10.

FIG. 14 is a plain view showing another pattern of a filter according to yet further embodiment.

FIG. 15 is a perspective view schematically showing a filter provided with the filter circuit shown in FIG. 14.

### DETAILED DESCRIPTION OF THE INVENTION

There will be described a filter circuit and a method of adjusting characteristics thereof according to an embodiment of the present invention with reference to the drawings.

Firstly, an example of the basic structure of a filter circuit according to an embodiment of the present invention will be described.

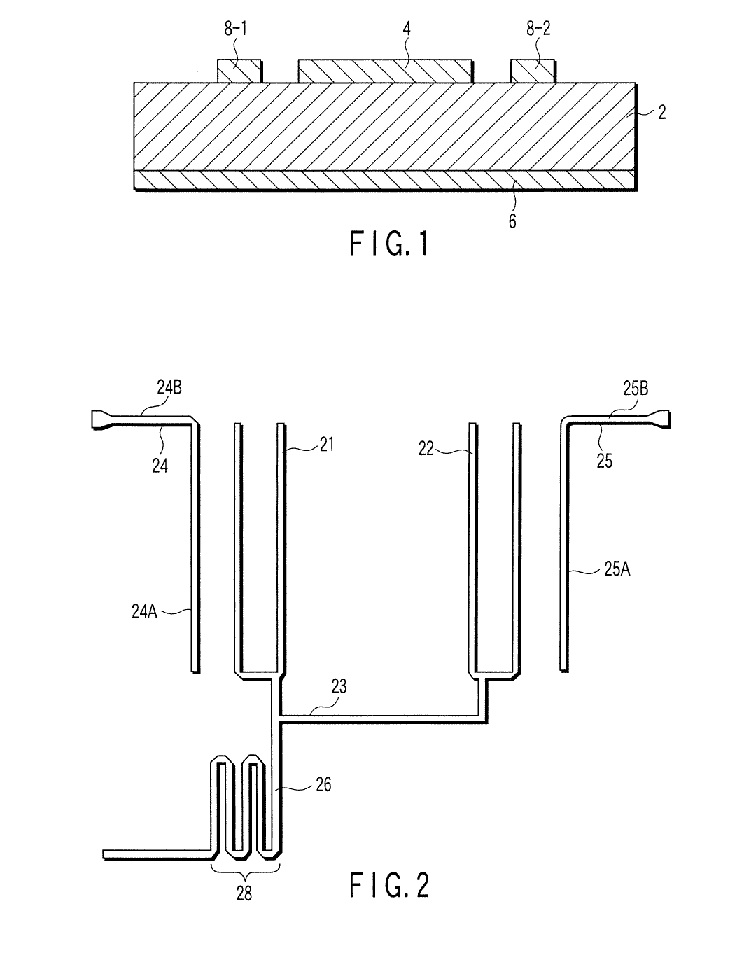

The filter circuit is formed as a micro strip line resonator device of superconductor type, as shown in FIG. 1. As shown in FIG. 1, the resonator device comprises a substrate 2, a resonator pattern 4 which is formed on the upper surface of the substrate 2, and excitation lines 8-1 and 8-2, i.e., an input section and an output section, which is formed on both sides of the pattern 4 on the upper surface of the substrate 2. Further, a thin film 6, e.g., a YBCO thin film formed of a Y-based copper oxide superconductor, is formed on the lower surface of the substrate 2. The substrate 2 is formed of, for example, an MgO disk having a diameter of about 50 mm, a thickness of 0.43 mm, and a relative dielectric constant of about 10.

The resonator pattern 4 is arranged in a region between the input and output sections, i.e., between the excitation lines 8-1 and 8-2. A thin film of a superconductor is formed into micro strip lines which are arranged to form the resonator pattern 4 and the excitation lines 8-1 and 8-2. The thin film 6 formed on the lower surface of the substrate 2 is connected to the ground. Here, the superconductor of the micro strip lines is formed of, for example, a YBCO thin film of a Y-series copper oxide high temperature superconductor in a thickness of approximately 500 nm. The line width of a strip line is approximately 0.4 mm. The superconductor film can be formed by a laser vapor deposition method, a sputtering method or a co-vapor deposition method.

Each section of the circuit pattern shown in FIG. 1 is formed with a certain thickness on the substrate 2. However, as the thickness is substantially smaller than that of substrate 2, this circuit pattern can be regarded as being formed virtually in planar manner, virtually, in a planar space.

FIG. 2 shows an example of the basic circuit pattern of the super conductor filter shown in FIG. 1. The circuit pattern shown in FIG. 2 comprises input-output lines 24, 25 formed on the substrate 2, resonators 21, 22 of the micro strip lines and a coupling transmission line 23 to which an open stub 26 is further connected so as to branch off from the line 23.

Each of the input-output lines 24, 25 is formed in L-shape. The linear portions 24A, 25A are arranged in just about parallel and linearly extended portions 24B and 25B are extended almost orthogonally in opposite directions against each other. The resonators 21 and 22 are arranged almost in parallel with these linear portions 24A, 25A, between the linear portions 24A, 25A of the input-output lines 24, 25. The open ends of the resonators 21 and 22 are directed to the side of the linearly extended portions 24B and 25B. Each of the resonators 21 and 22 is formed as a hair pin type half-wave resonator. The hair pin type half-wave resonators 21, 22 are arranged in parallel and in a manner in which the closed ends face the same direction. The transmission line 23 is connected to a portion on the corners of the closed ends of the half-wave resonators 21, 22, thereby coupling the resonators 21 and 22. The resonance frequency of the resonators 21 and 22 are set to 1.93 GHz. The input section 24 and the output section 25 are connected to a circuit outside the filter circuit. The open stub 26 branches off from the transmission line 23. The electric length of the open stub 26 is set to a half-wave length of a resonance wave length corresponding to a resonance frequency of 1.93 GHz or an integral multiple of the half-wave length. The circuit shown in FIG. 2 corresponds to a circuit pattern for measuring the coupling of the resonators 21, 22.

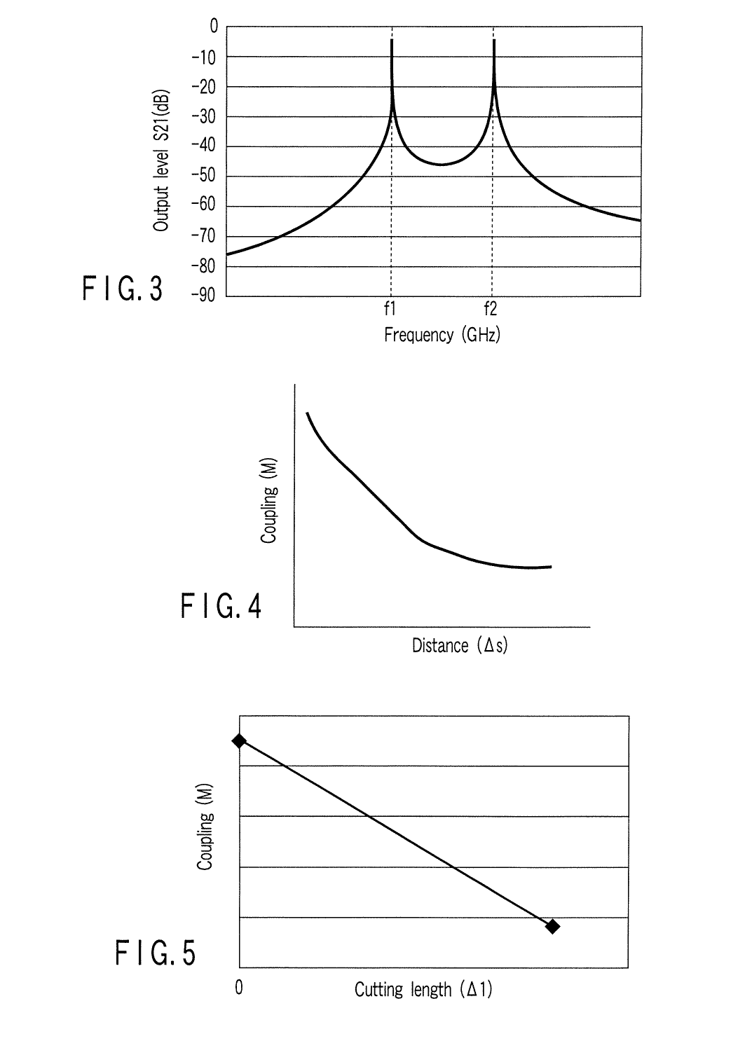

FIG. 3 exemplifies the passing amplitude characteristic of the circuit show in FIG. 2. In the graph showing the relation between output levels and frequencies in FIG. 3, two peaks P1, P2 indicating the coupling of the two resonators 21, 22 appear at frequencies f1, f2. Here, the coupling coefficient M of the resonators 21 and 22 is given by the following equation;

M=2 (f2−f1)/(f1+f2)

In the circuit shown in FIG. 2, a sapphire rod is arranged above the meander section of an open stub 26. The change in the coupling M is studied when the end of the rod is drawn close to the meander section. FIG. 4 is a graph showing such results. In the graph shown in FIG. 4, the horizontal axis indicates the distance Δs between the rod end and the meander section 28, and the vertical axis indicates the coupling M. From the graph in FIG. 4, it can be easily understood that as the rod is drawn closer to the meander section 28, the coupling M becomes larger as the distance Δs becomes smaller.

In the circuit shown in FIG. 2, the end of the open stub 26 is trimmed and the aspect of change in the coupling M is studied. The result thereby is shown in FIG. 5. In the graph shown in FIG. 5, the horizontal axis shows the length Δl by which the end of the open stub 26 is trimmed, and the vertical axis shows the coupling M. From the graph, it can be easily understood that as the trimmed length Δl becomes larger, the coupling M becomes smaller.

As mentioned above, by providing the open stub 26 branching off from the transmission line 23 which couples the resonators 21 and 22, and adjusting the electric length of the open stub 26 to a half-wave length of a resonance wave length corresponding to a resonance frequency or an integral multiple of the half-wave length, the coupling M between the resonators 21 and 22 can be adjusted large or small. Accordingly, by a circuitry in which the open stub 26 is connected to the transmission line 23 coupling the resonators 21 and 22, a filter circuit enabling adjustment of the coupling M between the resonators 21 and 22 is realized.

Alternatively, the electric length of the open stub 26 can be in the range of approximately ±5° against the value of the half-wave length of a resonance wave length corresponding to a resonance frequency or the integral multiple of the half-wave length. This electric length can achieve a desired coupling as a result of adjustment through a dielectric substance or by trimming the end portion.

Further, the electric length can be measured by two-dimensional or three-dimensional electromagnetic field simulation, based on, for example, the material of the dielectric substrate, and the material and width of the micro strip lines actually used in the filter circuit.

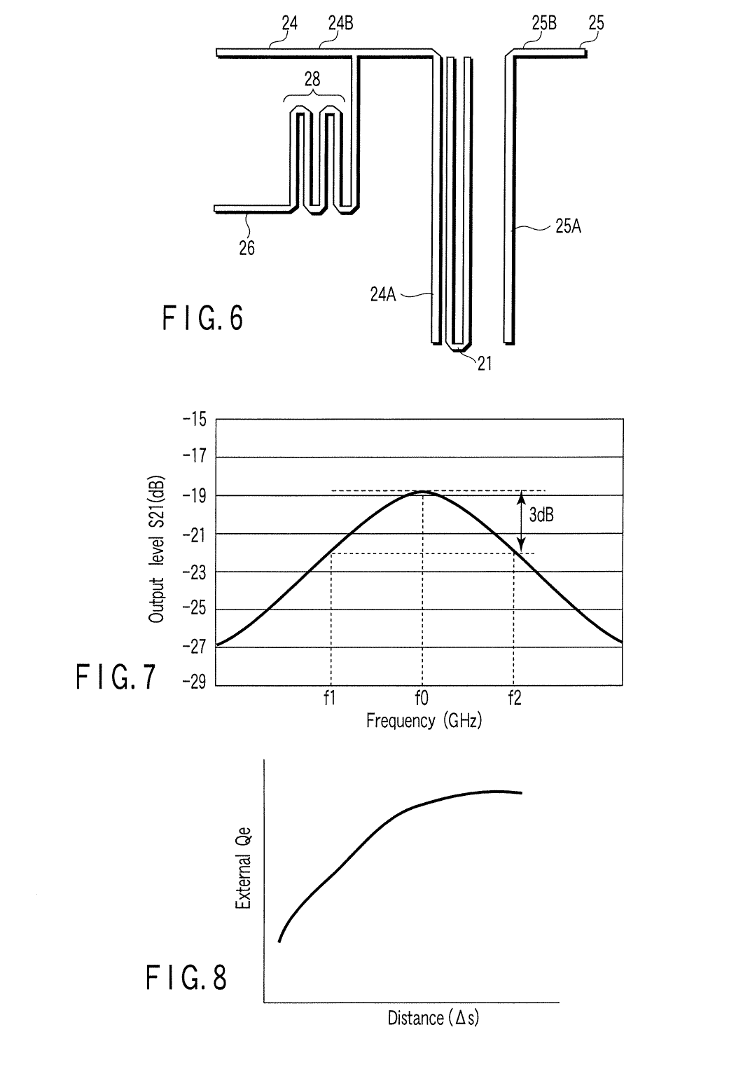

FIG. 6 shows a second pattern diagram for explaining the basic structure of the filter of the present invention.

The filter circuit shown in FIG. 6 has a superconductor micro strip line formed on an MgO substrate (not illustrated) having a thickness of approximately 0.43 mm and a relative dielectric constant of approximately 10. Here, the micro strip lines are formed from a thin film formed of a Y-based copper oxide high-temperature superconductor having a thickness of approximately 500 nm, and the line width of the strip line is set to approximately 0.4 mm. The superconductor thin film is formed by a laser vapor deposition method, sputtering method or a co-vapor deposition method.

In the filter circuit shown in FIG. 6, a resonator 21 is arranged between the linear portions 24A, 25A of the L-shaped input section 24 and output section 25, in parallel or nearly parallel with the linear portions 24A, 25A. The resonator 21 is a hair pin type half-wave resonator, and is set to a resonance frequency of 1.93 GHz. The extended portions 24B, 25B of the input section 24 and the output section 25 are connected to an external device or devices. The extended portion 24B of the input section 24 is formed in longer length than the extended portion 25B of the output section 25. The open stub 26 branches off from the extended portion 24B. The electric length of the open stub 26 is set to a half-wave length of a resonance wavelength corresponding to a resonance frequency of 1.93 GHz or an integral multiple of the half-wave length.

The filter circuit shown in FIG. 6 is configured to measure external Q, Qe corresponding to the resonator 21. The distance between the linear portion 24A and the resonator 21 is made smaller than the distance between the linear portion 25A and the resonator 21. Compared to the coupling between the input section 24 and the linear portion 24A, the coupling of the output section 25 with the resonator 21 is set substantially smaller. The external Qe subject to the excitation from the input section 4 is measured.

FIG. 7 shows the bandpass amplitude characteristic of the filter circuit shown in FIG. 6. In FIG. 7, the horizontal axis indicates frequency and the vertical axis indicates an output level. The external Qe for the resonator 21 is given by the following equation;

Qe=f0/(f2−f1)

In the filter circuit shown in FIG. 6, a sapphire rod is arranged on the meander section 28 of an open stub 26 and changes in Qe are similarly studied when the end of the rod is drawn close to the meander section 28. The results thereby are shown in the graph of FIG. 8, which shows the relation of the distance Δs between the rod end and the meander section 28 to the external Qe. It can be easily understood from FIG. 8 that as the rod is drawn closer to the meander section 28 and the distance Δs becomes smaller, the external Qe can be made smaller.

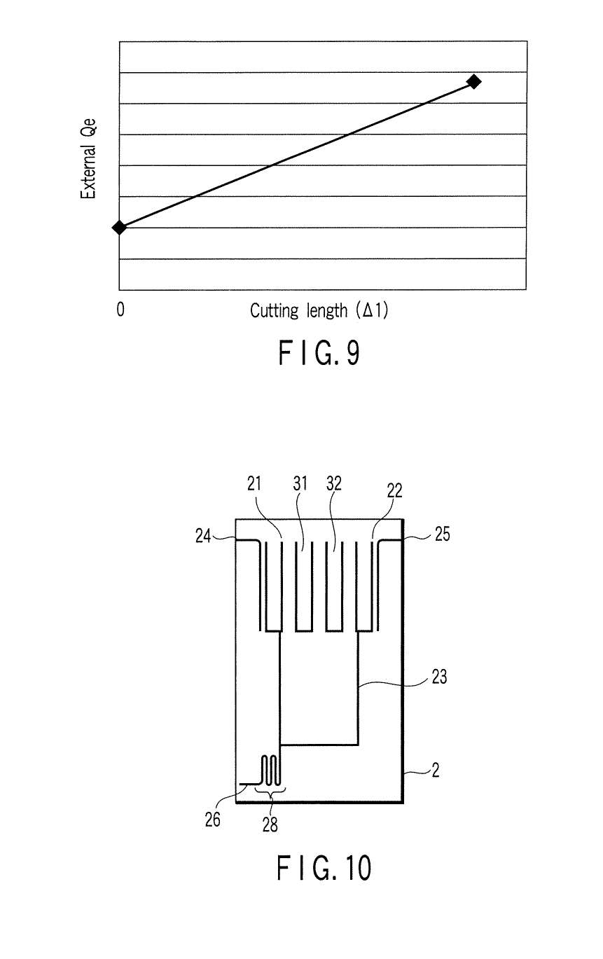

When studying the change of external Qe upon trimming the end of the open stub 26 in the filter circuit shown in FIG. 6, a graph shown in FIG. 9 is obtained. FIG. 9 shows the relation between length Δl to be trimmed from the end of the open stub 26 and the external Qe. As is obvious from FIG. 9, it can be easily understood that the eternal Qe becomes larger as the length Δl to be trimmed increases.

As mentioned above, in a filter circuit where the open stub 26 is branched off from the input section 24 for exciting the resonant element 21, and the electric length of the open stub 26 is set to a half-wave length of a resonance wave length corresponding to a resonance frequency or an integral multiple of the half-wave length, it can be easily understood that the external Q may be adjusted large or small by adjusting the electric length of the open stub 26. Accordingly, by providing the open stub 26 in this manner on a filter circuit, a filter circuit in which the external Q is adjustable can be realized.

In addition, the electric length of the open stub 26 may be given allowance of approximately ±5° against the value of the half-wave length of the resonance wave length corresponding to a resonance frequency or the integral multiple of the half-wave length. A desired Qe may be achieved as a result of adjustment by locating the dielectric rod or by trimming the end portion.

Further, the electric length can be measured from an electromagnetic field simulation.

### First Embodiment

FIG. 10 shows a pattern of the filter circuit according to a first embodiment of the present invention.

This filter circuit has a superconductor micro strip line formed on an MgO substrate having a thickness of approximately 0.43 mm and a relative dielectric constant of approximately 10. Here, a thin film formed of a Y-series copper oxide high-temperature superconductor having a thickness of approximately 500 nm is used for the superconductor of the micro strip lines, and the line width of the strip line is set to approximately 0.4 mm. The superconductor thin film is formed by, such as, a laser vapor deposition method, sputtering method or a co-vapor deposition method.

The filter circuit shown in FIG. 10 is a pseudo elliptical function type four-stage filter arranged with four hair pin type half-wave length resonators 21, 22, 31 and 32 between the input section 24 and output section 25. The center frequency of the filter is set to 1.93 GHz. The transmission line 23 couples the resonators 21, 22 which are arranged the nearest to the input section 24 and the output section 25. The input section 24 and the output section 25 are connected to external devices. The open stub 26 is arranged to branch off from the transmission line 23 for connecting the resonators 21 and 22. The electric length of the open stub 26 is set to a half-wave length of the resonance wave length corresponding to the resonance frequency of 1.93 GHz or an integral multiple of the half-wave length. The open stub 26 is provided with a meander section 28 and has its end arranged on the edge of the substrate.

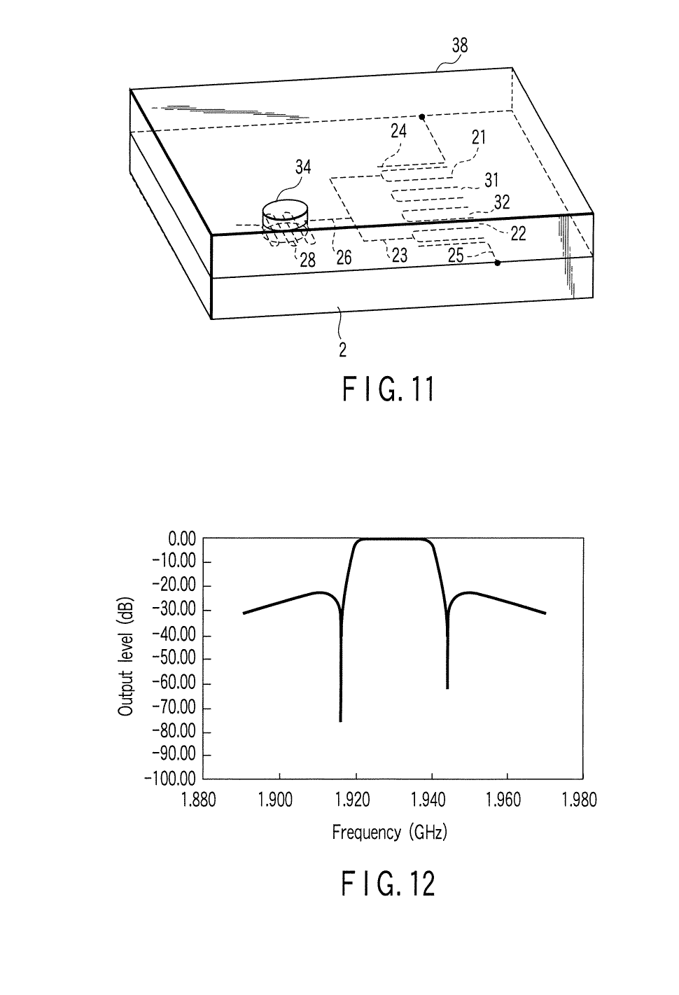

As shown in FIG. 11, a filter has a configuration that the filter circuit shown in FIG. 10 is received in a case 38. A sapphire rod 34 is provided on the case 38 in which an end face of the sapphire rod 34 is faced to the meander section 28 of the open stub 26. In order to adjust the distance ΔS between the end of rod 34 and the meander section 28, a screw structure for the sapphire rod 34, for instance, is provided to the case 38 to support the rod 34. In the filter shown in FIG. 11, the distance ΔS between the end of the sapphire rod 34 and the meander section 28 can be adjusted by adjusting the screw structure. By adjusting the distance ΔS, the coupling between the resonators 21 and 22 can be adjusted, thereby providing the filter circuit with a desired characteristic as shown in FIG. 12.

Meanwhile, it is obvious that the end of the open stub 26 may be connected to other elements.

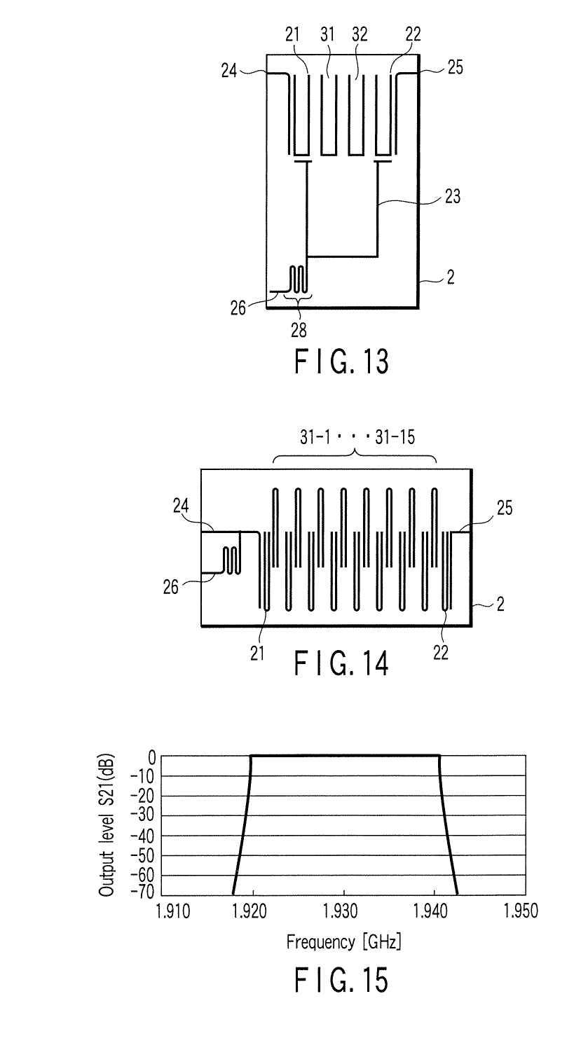

Alternatively, the present embodiment uses line coupling via a tap described in JP-A 2004-336605 (KOKAI). However, it is also fine to use line coupling via a gap described in IEEE Microwave Theory and Techniques Symposium Digest (1999), page 1547. Even in such case, similarly, there may be provided an open stub branching from an arbitrary point of the transmission line so that it is possible to adjust coupling. In other words, as for the filter circuit, the transmission line 23 may be connected directly to the resonators 21, 22 as shown in FIG. 10, or coupled spatially to the resonators 21, 22 as shown in FIG. 13.

In addition, the present embodiment uses a hair pin type resonator as its resonator. However, it shall not necessarily be restricted to the hair pin type resonator, and various resonators comprised of micro strip line or lines can be used.

### Second Embodiment

FIG. 14 shows a pattern of the filter circuit according to a second embodiment of the present invention.

The filter circuit shown in FIG. 14 has a superconductor micro strip line formed on an MgO substrate having a thickness of approximately 0.43 mm and a relative dielectric constant of approximately 10. Here, the superconductor of the micro strip line uses a thin film formed of a Y-based copper oxide high-temperature superconductor having a thickness of approximately 500 nm, and the line width of the strip line is set to approximately 0.4 mm. The superconductor thin film is formed by a laser vapor deposition method, sputtering method or a co-vapor deposition method.

In the filter circuit shown in FIG. 14, a 17-stage filter of Chebyshev function type comprising 17 pieces of hair pin type half-wave length resonators 12, 22, 31-1 to 31-15 between the L-shaped input section 4 and output section 5 is arranged. The center frequency of the filter is set to 1.93 GHz. The input section 24 and output section 25 are connected to an external device or devices, and the open stub 26 branching off from the input section 4 to excite the resonator 21 is provided in the filter circuit. The electric length of the open stub 26 is set to a half-wave length of a resonance wave length corresponding to the resonance frequency of 1.93 GHz or an integral multiple of the half-wave length. The open stub 26 is provided with the meander section 28, and its end is extended to the edge of the substrate 2.

Similarly, as shown in FIG. 11, the sapphire rod 34 is arranged above the meander section 28 of the open stub 26. By adjusting the distance ΔS between the end of the rod 34 and the meander section, the external Q can be adjusted. Accordingly, by adjusting the external Q, a desired characteristic as shown in FIG. 15 may be given to the filter circuit.

Meanwhile, also in the filter circuit shown in FIG. 14, it is obvious that the end of the open stub 26 may be connected to another element. For example, the end of the open stub 26 may be connected to yet another filter circuit, thereby forming a multiplexer.

Additionally, this embodiment uses a gap excitation which couples the input line to a resonator via a gap as described in IEEE Transaction on Microwave Theory and Techniques, Vol. 20 (1972), page 719. However, it is also possible to use a tap excitation which couples the input line to a resonator via a tap as described in IEEE Transaction on Microwave Theory and Techniques, Vol. 27 (1979), page 44. Even in such case, by similarly providing the open stub branching from an arbitrary point of the input section, the external Q may be adjusted.

Alternatively, although the filter circuit shown in FIG. 14 is not provided with a transmission line which couples the resonators, it is possible to provide the transmission line or lines in the filter circuit in which the resonators are coupled by the transmission line or lines 23 as shown in FIG. 13. As for the filter circuit being line coupled by the transmission line 23, obviously, an open stub for line coupling adjustment and an open stub for external Q adjustment may be provided respectively.

Further, in the filter circuit, a hair pin type resonator is used as the resonator. However, it is not restricted to the hair pin type resonators. Thus, it is possible to apply the micro strip line or lines to form various types of resonators for the filter circuit.

As mentioned above, it is possible to realize a filter circuit which can adjust the coupling between resonators and external Q to a desired value.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A filter circuit having a resonance frequency, comprising:
a dielectric substrate having a first surface and a second surface opposed to the first surface;
a conductor layer formed on the first surface;
input and output sections formed of micro strip lines on the second surface;
resonant conductors arranged between the input and output sections and formed of micro strip lines on the second surface;
a transmission line formed of a micro strip line on the second surface and coupled between the resonant conductors; and
an open stub formed of a micro strip line on the second surface and branching off from the transmission line, the electric length of the open stub being an integral multiple of a half-wave length of a resonance wave length corresponding to the resonance frequency.

2. The filter circuit according to claim 1, wherein the open stub is provided with a meander section.

3. The filter circuit according to claim 1, wherein the open stub has an end portion extended to the second surface.

4. The filter circuit according to claim 1, wherein the micro strip line is made of a superconductor.

5. The filter circuit according to claim 1, further comprising a dielectric substance having an end face which is so arranged as to be opposed to the open stub with a gap, and an adjusting section configured to adjust a distance between the end face and the open stub.

6. A method of adjusting the filter circuit according to claim 1, the filter circuit further comprising a dielectric substance having an end face which is so arranged as to be opposed to the open stub with a gap, said method comprising adjusting a distance between the end face and the open stub to set the filter circuit to have a predetermined characteristic.

7. A method of adjusting the filter circuit according to claim 1,
the method comprising trimming an end of the open stub to set the filter circuit to have a predetermined characteristic.

8. A filter circuit having a resonance frequency, comprising:
a dielectric substrate having a first surface and a second surface opposed to the first surface;
a conductor layer formed on the first surface;
input and output sections formed of micro strip lines on the second surface;
a resonant conductor arranged between the input and output sections and formed of a micro strip line on the second surface; and
an open stub formed of a micro strip line on the second surface and branching off from one of the input and the output sections, the electric length of the open stub being an integral multiple of a half-wave length of a resonance wave length corresponding to the resonance frequency.

9. The filter circuit according to claim 8, wherein the open stub is provided with a meander section.

10. The filter circuit according to claim 8, wherein the open stub has an end portion extended to the second surface.

11. The filter circuit according to claim 8, wherein the micro strip line is made of a superconductor.

12. The filter circuit according to claim 8, further comprising a dielectric substance having an end face which is so arranged as to be opposed to the open stub with a gap, and an adjusting section configured to adjust a distance between the end face and the open stub.

13. A method of adjusting the filter circuit according to claim 8, the filter circuit further comprising a dielectric substance having an end face which is so arranged as to be opposed to the open stub with a gap, said method comprising adjusting a distance between the end face and the open stub to set the filter circuit to have a predetermined characteristic.

14. A method of adjusting the filter circuit according to claim 8, the method comprising trimming an end of the open stub to set the filter circuit to have a predetermined characteristic.
